(19) United States
(12) Patent Application Publication
(10) Pub. No.: US 2010/0014460 A1
(43) Pub. Date: Jan. 21, 2010

(54) SENSOR NETWORK MAC SYSTEM FOR MULTIHOP COMMUNICATION

(75) Inventors: Chang-Sub SHIN, Daejeon-city (KR); Wun Cheol Jeong, Daejeon-city (KR); So Young Hwang, Busan-city (KR); Anseok Lee, Gyeongsangbuk-Do (KR); Seong Soon Joo, Daejeon-city (KR); Jong Suk Chae, Daejeon-city (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/501,006

(22) Filed: Jul. 10, 2009

(30) Foreign Application Priority Data
Jul. 11, 2008 (KR) 10-2008-0067810
Sep. 26, 2008 (KR) 10-2008-0094706
Jul. 9, 2009 (KR) 10-2009-0062564

(51) Int. Cl. H04W 84/18

(52) U.S. Cl. 370/328

(57) ABSTRACT

Provided is a method of synchronizing time for a multihop sensor network. According to the method, receiving nodes accurately synchronize time by adding a delay transmission time value to a beacon frame in a beacon mode, or by using a time synchronization frame and time synchronization acknowledgement frame containing time information and superframe structure information in a non-beacon mode. Accordingly, a mesh topology is supported, and a media access control (MAC) structure having high reliability and low delay time is provided.

### CROSS-REFERENCE TO RELATED PATENT APPLICATION

This application claims the benefit of Korean Patent Application No. 10-2008-0067810, filed on Jul. 11, 2008, Korean Patent Application No. 10-2008-0094706, filed on Sep. 26, 2008, and Korean Patent Application No. 10-2009-0062564, filed on Jul. 9, 2009, in the Korean Intellectual Property Office, the disclosures of which are incorporated herein in their entirety by reference.

### BACKGROUND OF THE INVENTION

1. Field of the Invention

The present invention relates to a multihop sensor network media access control (MAC) technology that operates in real-time and is highly reliable, and more particularly, to a method of clock synchronization for a multihop sensor network.

2. Description of the Related Art

IEEE 802.15.4 Media Access Control (MAC) is a sensor network MAC technology for realizing real-time and highly reliable services. According to IEEE 802.15.4, a network is formed in a tree structure having a PAN coordinator (PNC) at its peak, and assigns an independent active duration to each node according to a scheduling method supported by a user and supports communication during the active duration. Here, in a beacon mode, performance may deteriorate as beacon frames collide with each other, and a mesh network structure is not supported since only a tree network is supported. Also in a non-beacon mode, an MAC superframe structure that has high reliability and a short delay time cannot be formed, and thus time division multiple access (TDMA) & fiber hub (FH) MAC cannot be supported.

### SUMMARY OF THE INVENTION

The present invention provides a method of synchronizing time of a node forming a multihop sensor network, wherein receiving nodes accurately synchronize time by adding a delay transmission time value to a beacon frame so as to reduce a beacon frame collision in a beacon mode, and a beaconing problem in a conventional beacon mode is solved by using a time synchronization frame and time synchronization acknowledgement frame containing time information and superframe structure information, in a non-beacon mode.

According to an aspect of the present invention, there is provided a method of synchronizing time of a node forming a multihop sensor network, the method including: generating a timestamp after delaying transmitting of a beacon frame; and adding a delayed time value and a timestamp value to the beacon frame.

According to another aspect of the present invention, there is provided a method of synchronizing time of a node in a multihop sensor network, the method including: synchronizing time based on a timestamp value of a first time synchronization frame received from a neighboring node; generating a second time synchronization frame having an increased hop distance value; and broadcasting the second time synchronization frame to the multihop sensor network.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a structure for updating time synchronization information in a beacon mode of IEEE 802.15.4 Media Access Control (MAC), according to an embodiment of the present invention;

FIG. 2 is a diagram for describing a method of synchronizing time via a time synchronization frame in an MAC layer in a non-beacon mode, according to an embodiment of the present invention;

FIGS. 3A and 3B are diagrams for respectively describing structures of a time synchronization frame and a time response frame for time synchronization, according to an embodiment of the present invention;

FIGS. 4A through 4H are diagrams for describing network-wide time synchronization processes by using the time synchronization frame of FIGS. 3A and 3B;

FIGS. 5A and 5B are diagrams for respectively describing structures of a time synchronization frame and a time synchronization request frame, according to an embodiment of the present invention;

FIG. 6 is a diagram for describing a network-wide time synchronization process by using the time synchronization frame of FIG. 5A;

FIGS. 7A and 7B are diagrams for describing a method of synchronizing time, when a plurality of time synchronization frames are received from a neighboring node, according to an embodiment of the present invention;

FIG. 8 is a diagram for describing a method of estimating and compensating for time information without receiving a periodical time synchronization frame, according to an embodiment of the present invention;

FIG. 9 is a diagram for describing a time synchronization process according to an embodiment of the present invention;

FIG. 10 is a flowchart illustrating a method of synchronizing time in a beacon mode, according to an embodiment of the present invention; and

FIG. 11 is a flowchart illustrating a method of synchronizing time in a non-beacon mode, according to an embodiment of the present invention.

### DETAILED DESCRIPTION OF THE INVENTION

Hereinafter, the present invention will be described more fully with reference to the accompanying drawings, in which exemplary embodiments of the invention are shown. In the drawings, like reference numerals denote like elements. While describing the present invention, detailed descriptions about related well-known functions or configurations that may diminish the clarity of the points of the present invention will be omitted.

Also, when a part “includes” an element, the part may further include another element, unless otherwise defined.

Multihop time synchronization in a sensor network is an algorithm for adjusting time of all nodes in the sensor network to a local time of a node having a standard time. Examples of a method of synchronizing time in a multihop sensor network include a beaconing method and a non-beaconing method. The present invention suggests an algorithm for preventing receiving nodes from updating time information to a wrong time value by including delayed time information in a beacon frame, when the beacon frame is not transmitted within a determined time. Also, the present invention provides a method of adjusting synchronization of the entire network, by using a periodical time synchronization frame instead of a beacon frame.

The present invention suggests two types of synchronizing methods using time synchronization frames received from a neighboring node for a certain period of time. According to a first method, a node having the lowest timestamp value from among received time synchronization frames is determined as a reference node, and time synchronization is performed based on the timestamp value of the reference node. According to a second method, time synchronization is performed by using an average value of timestamp values of received time synchronization frames.

Also, the present invention suggests a method of compensating a clock without receiving a periodical time synchronization frame. Each node stores a timestamp value of a consecutive time synchronization frame that is periodically received. When a node does not receive a time synchronization frame due to a network trouble, the node compensates its clock by using consecutive timestamp values that are previously received.

Terms used in the present invention are defined as follows.
PAN Coordinator (PNC): A controller of a sensor network. It corresponds to the peak of a tree structure.
Hop Distance Value: A hop counter value from the PNC.
Timestamp: A time value for updating time information
Clock Compensation: A method of reducing a time synchronization error value.

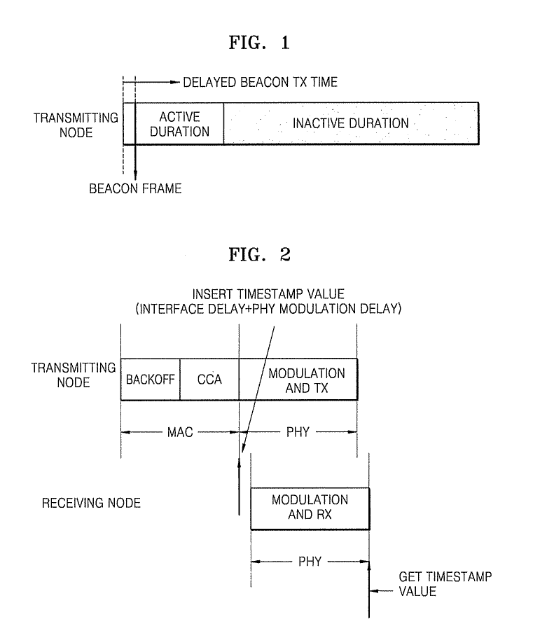

FIG. 1 is a diagram illustrating a structure for updating time synchronization information in a beacon mode of IEEE 802.15.4 Media Access Control (MAC), according to an embodiment of the present invention.

Since a beacon frame may not be transmitted due to packet collision, each node adds a delayed time value generated by performing backoff and clear channel assessment (CCA) on a beacon frame before transmitting the beacon frame. Receiving nodes, which received the beacon frame, update time synchronization information by using the delayed time value.

Table 1 shows an example of a time synchronization specification field in a beacon frame, in a beacon mode.

TABLE 1

| Bits: 0 | 1-4 | 5-7 | 8-31 |
|---|---|---|---|
| Deferred Beacon | Deferred Beacon | Reserved | Beacon Timestamp |
| Flag | Time | | |

A deferred beacon flag subfield shows whether CCA is required before transmitting a beacon frame. When the deferred beacon flag subfield is set to 1, a device performs CCA before transmitting a beacon frame, and when the deferred beacon flag subfield is set to 0, a device does not perform CCA before transmitting a beacon frame. A deferred beacon time subfield shows a number of times backoff is performed for CCA. When the deferred beacon flag subfield is set to 0, the deferred beacon time subfield is ignored. A beacon timestamp subfield shows a beacon transmission time for time synchronization during a symbol period.

A transmitting node generates a timestamp value after performing the CCA and backoff, estimates an interface delay value between an MAC layer and a physical (PHY) layer, and a modulation delay value in the PHY value, and adds the interface delay value and modulation delay value to the timestamp value. The delayed time value generated by performing CCA and backoff is represented through the deferred beacon flag and deferred beacon time subfields.

Processes of performing time synchronization when a new node enters a network will now be described.

The new node finds a neighboring node through a scanning process. The new node associates with one of neighboring nodes in order to enter the network. The neighboring node associating with the new node becomes a parent node of the new node. A PNC of the network recognizes the new node, and determines a time for transmitting a beacon of the PNC. A timestamp value of the beacon is set to a time immediately before the transmitting of a beacon frame. The new node that received the beacon frame synchronizes time with the PNC. When a node collides with another node, the node tries re-transmission after backoff. Here, the timestamp value of the beacon is no longer valid. Accordingly, the PNC includes information about the requirement of CCA in a deferred beacon flag, and thus, the new node determines that the PNC used CCA for beacon transmission. The PNC may add the number of times backoff is performed for successful beacon transmission in the beacon. When the PNC transmitted the beacon after performing backoff 3 times, a deferred beacon time value may be set to 3. Accordingly, the node that received the beacon accurately determines a point of time when the beacon is transmitted.

FIG. 2 is a diagram for describing a method of synchronizing time via a time synchronization frame in an MAC layer in a non-beacon mode, according to an embodiment of the present invention.

A transmitting node generates a timestamp value including a time value after CCA and backoff, an estimated interface delay value between an MAC layer and a PHY layer, and an estimated modulation delay value in the PHY layer, and inserts the timestamp value into a time synchronization frame. Here, the transmitting node also inserts a time value indicating the time taken to perform to perform CCA and backoff in the MAC layer into the time synchronization frame. The time synchronization frame may further include surperframe structure information of a network and other management information.

A receiving node obtains the timestamp value including the time value indicating the time taken to perform CCA and backoff in the MAC layer, the estimated interface delay value, and the estimated modulation delay value from the received time synchronization frame, and synchronizes time with the transmitting node.

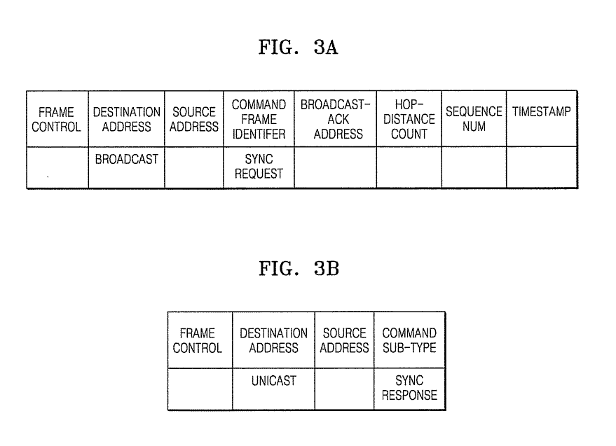

FIGS. 3A and 3B are diagrams for respectively describing structures of a time synchronization frame and a time response frame for time synchronization, according to an embodiment of the present invention.

All nodes excluding an end device may transmit the time synchronization frame of FIG. 3A.

A destination address field must always include a broadcast address. A command frame identifier field indicates that the time synchronization frame is a time synchronization request command. A broadcast acknowledgement (Ack) address field includes a value for transmitting Ack information to a neighboring node that transmitted a previous time synchronization frame. A hop distance count field includes a hop count value calculated by each node whenever a time synchronization frame is transmitted. Data flooding or a backward time error may be prevented by using the hop count value. A timestamp field includes a timestamp value as a time value for time information.

The time response frame of FIG. 3B is used by an end device and notifies a neighboring node about reception of a time synchronization frame.

A destination address field includes an address of a node that transmitted a time synchronization frame and enables the time response frame to be unicasted. A command sub-type field indicates that the time response frame is a time synchronization response.

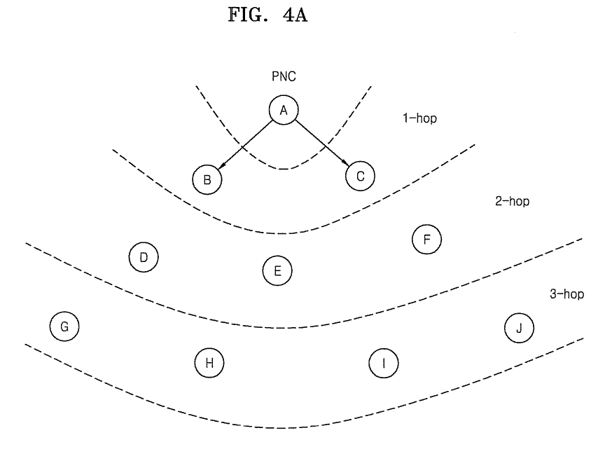

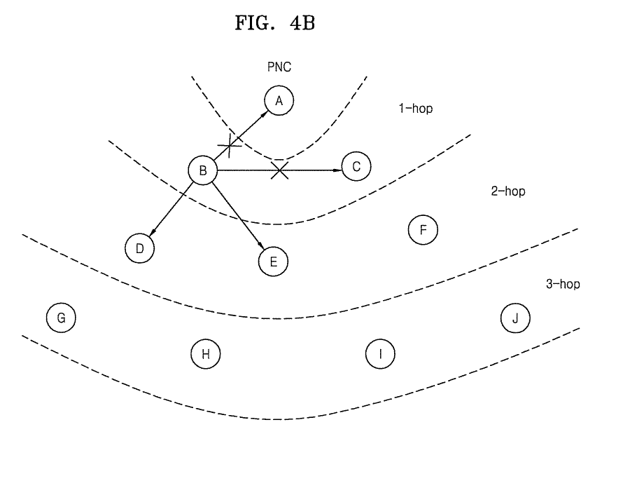

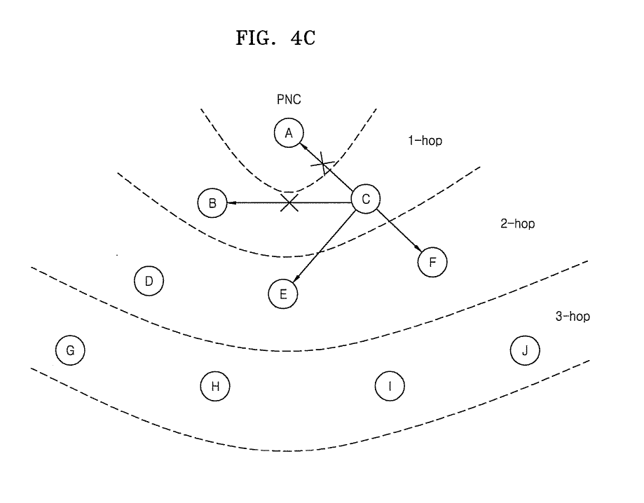

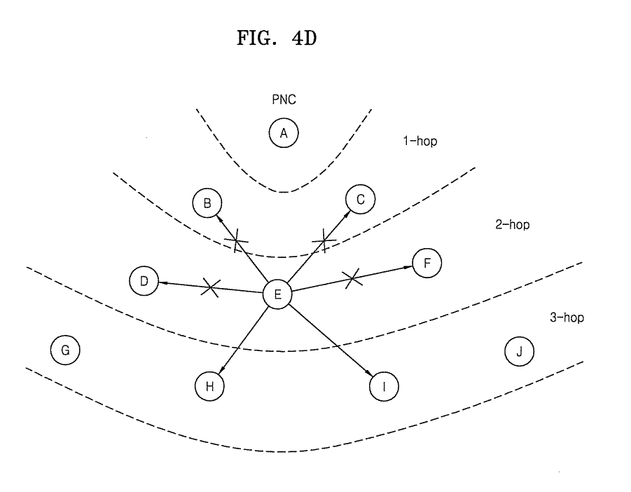

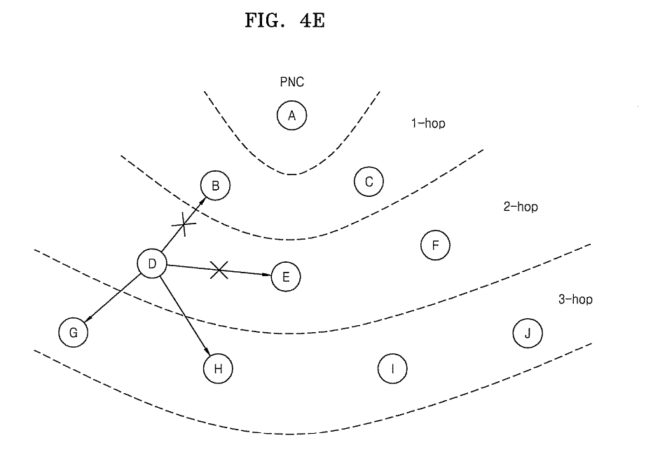

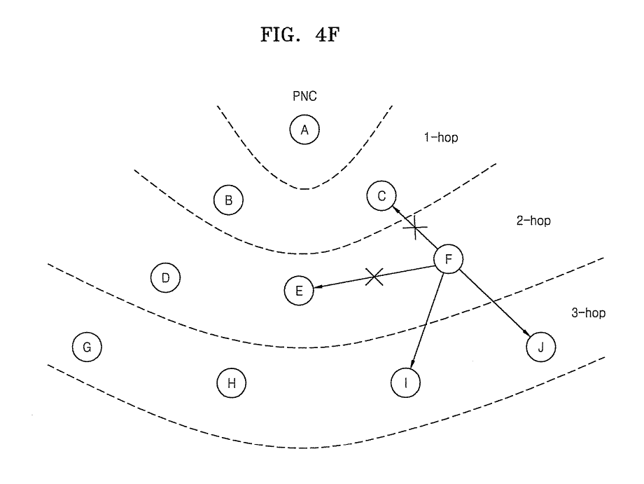

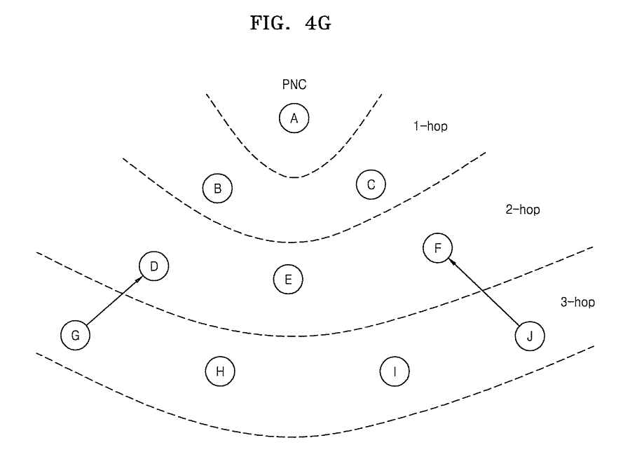

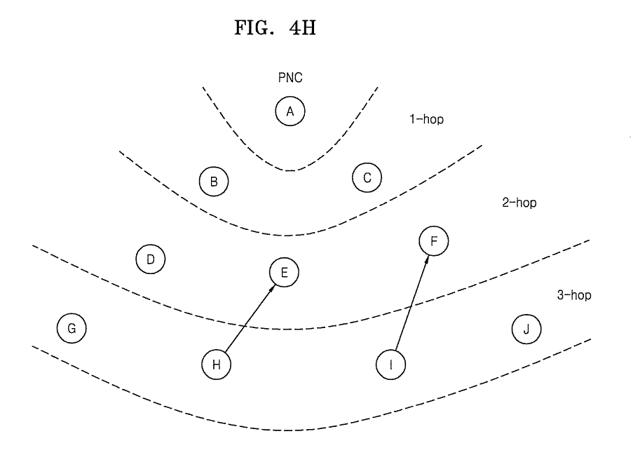

FIGS. 4A through 4H are diagrams for describing network-wide time synchronization processes by using the time synchronization frames of FIGS. 3A and 3B.

The time synchronization processes start from a PNC (a node A). A time synchronization frame is broadcasted to lower nodes (FIG. 4A). Nodes adjacent to the PNC perform time synchronization by using a timestamp value of a received time synchronization frame. Then, the time synchronization frame is re-broadcasted by increasing a hop distance value by 1 (FIGS. 4B through 4F). Each node receives time synchronization frames from neighboring nodes for a certain period of time, and perform synchronization by using a timestamp value of a node having the lowest hop distance value. When a hop distance value of a current time synchronization frame is larger than a hop distance value of a previous time synchronization frame, data of the current time synchronization frame is dropped. As such, time synchronization is sequentially performed until an end device is reached, and thus the entire network is synchronized. The end device unicasts a time response frame to the node that transmitted the time synchronization frame (FIGS. 4G through 4H).

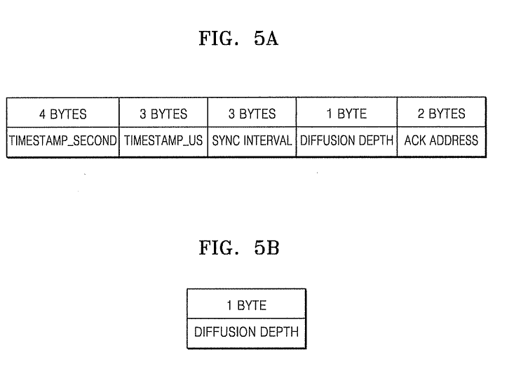

FIGS. 5A and 5B are diagrams for respectively describing structures of a time synchronization frame and a time synchronization request frame, according to an embodiment of the present invention.

The time synchronization frame of FIG. 5A has a structure that can be transmitted by all nodes in a network, including an end device, and does not require a separate time response frame. A Timestamp_second field indicates a time value in units of seconds. A Timestamp_us field indicates a time value in units of microseconds. A Sync interval field indicates an interval value for periodically transmitting a time synchronization frame. A Diffusion depth field indicates a hop count value of a time synchronization frame. When the hop count value is small more accurate time synchronization is performed, and thus is referred to when a reference node to receive a time synchronization frame is selected from among neighboring nodes. An Ack address field includes information for transmitting an acknowledgement to a node that transmitted a time synchronization frame.

The time synchronization request frame of FIG. 5B requests a neighboring node to transmit a time synchronization frame, when the time synchronization frame is lost. The time synchronization request frame includes a Diffusion depth field that indicates a hop count value of a node that requests the time synchronization frame.

Examples of PIB?? (full name??) and a primitive, when the time synchronization frame is applied are respectively shown in Tables 2 and 3.

TABLE 2

| Attribute | Type | Description |
|---|---|---|
| macSyncInterval | 3 Bytes | Number of intervals for |
| | | resynchronization |
| macReceivedTimestamp | 3 Bytes | Time of receiving first bit of SFD |
| | | field. Symbol Unit |
| macReceivedTimestamp | List | Consecutive timestamp value of |
| List | | received synchronization frame. |
| | | For software time compensation |

TABLE 3

| Name | Request | Indication | Response | Confirm | Description |
|---|---|---|---|---|---|
| MLME- | ∘ | | | ∘ | Starting of |
| START- | | | | | synchronization |
| SYNC | | | | | by PNC |
| MLME- | | ∘ | | | Notifying |
| SYNC- | | | | | synchronization |
| FAIL | | | | | failure to |
| | | | | | upper layer |

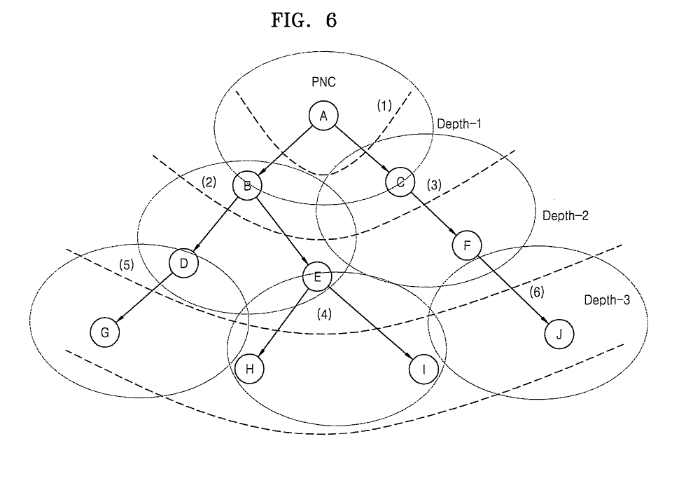

FIG. 6 is a diagram for describing a network-wide time synchronization process by using the time synchronization frame of FIG. 5A.

A PNC (node A) starts synchronization by broadcasting a time synchronization frame. A hop distance value of the time synchronization frame increases by 1 as the time synchronization frame moves to a lower node. The time synchronization frame may include additional information, such as superframe structure information.

Coordinators and an end device (node B through node J) receive a time synchronization frame of a device having the lowest depth, or a time synchronization frame including the latest timestamp value for time synchronization. The coordinators and the end device increase a hop count value, and broadcasts a time synchronization response frame indicating that the time synchronization frame is received, by using a broadcast acknowledgement address. Data flooding or a backward time error may be prevented by using the hop count value.

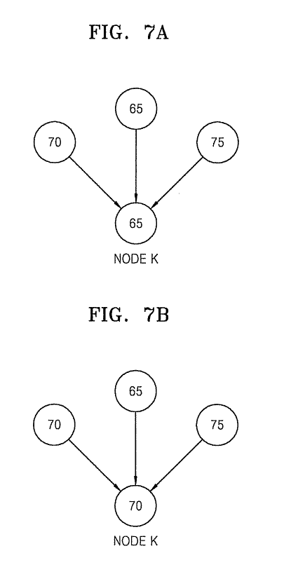

FIGS. 7A and 7B are diagrams for describing a method of synchronizing time, when a plurality of time synchronization frames are received from a neighboring node, according to an embodiment of the present invention.

In FIG. 7A, the lowest value from among timestamp values of time synchronization frames of neighboring nodes is selected, wherein the time synchronization frames are received from the neighboring nodes for a predetermined time. Here, a node K selects 65, which is the lowest value from among 65, 70, and 75, which are the timestamp values received from neighboring nodes.

In FIG. 7B, an average value of timestamp values of time synchronization frames of neighboring nodes is selected, wherein the time synchronization frames are received from the neighboring nodes for a predetermined time. Here, a node K selects 70, which is an average value of 65, 70, and 75, which are the timestamp values received from the neighboring nodes.

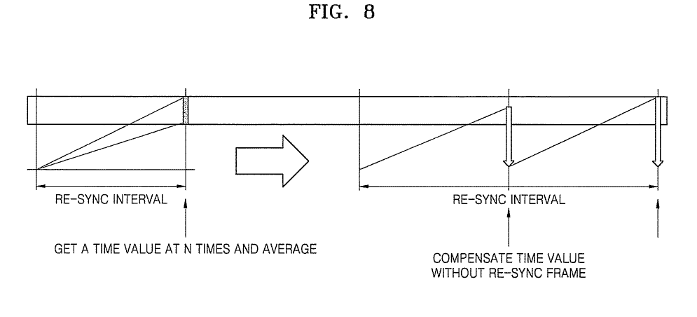

FIG. 8 is a diagram for describing a method of estimating and compensating for time information without receiving a periodical time synchronization frame, according to an embodiment of the present invention.

Each node stores consecutive timestamp values of time synchronization frames that are periodically received as a list. When a node fails to receive a time synchronization frame at an expected point of time, the node compensates a time value based on the list of consecutive timestamp values. Alternatively, the node compensates the time value based on an average value of error compensated values of the consecutive timestamp values.

An error compensation value (Tₑ) may be calculated as follows. Here, n denotes a number of pre-stored sample values, and Tₖ denotes a current time.

$${T}_{e} = \frac{1}{n} {\sum }_{i = 0}^{n - 1} {T}_{k - i}$$

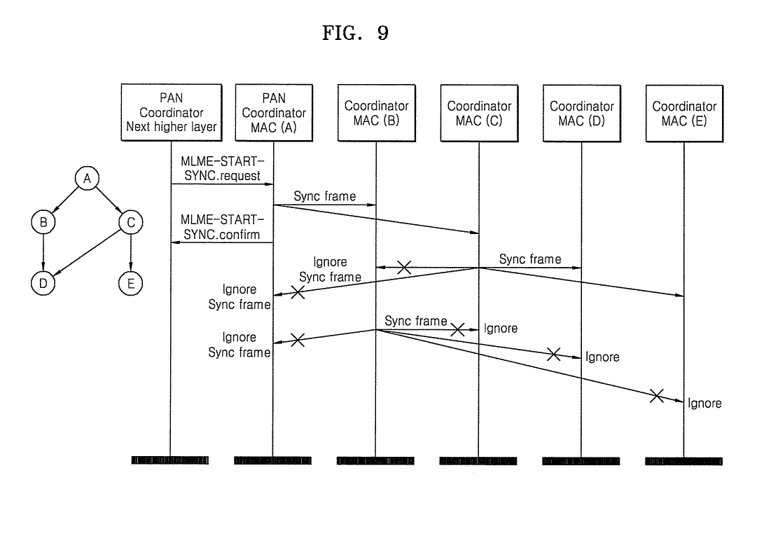

FIG. 9 is a diagram for describing a time synchronization process according to an embodiment of the present invention.

An MAC layer of a PNC (node A) receives MLME-START-SYNC.request primitive from an upper layer, and generates and broadcasts a time synchronization frame. The MAC layer of the PNC transmits MLME-START-SYNC.confirm primitive to the upper layer. Upon receiving the time synchronization frame from the PNC, coordinators (node B and node C) perform time synchronization. The coordinators re-broadcast the time synchronization frame to lower coordinators (node D and node E) after increasing a hop distance value by 1. The nodes D and E perform time synchronization by receiving the time synchronization frame from the node C, and drop the time synchronization frame received from the node B. Also, an upper node drops a time synchronization frame from a lower node.

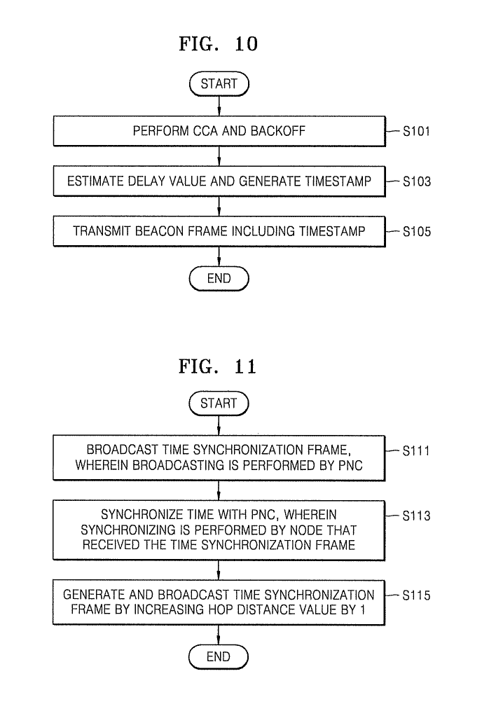

FIG. 10 is a flowchart illustrating a method of synchronizing time in a beacon mode, according to an embodiment of the present invention.

In operation S101, a transmitting node that is to transmit a beacon performs CCA and backoff in order to prevent a collision from occurring.

In operation S103, the transmitting node generates a timestamp after CCA and backoff. Here, the transmitting node estimates a delay value. The delay value includes an interface delay value between an MAC layer and a PHY layer, and a modulation delay value in the PHY layer, besides a delayed time value generated by performing CCA and backoff. The interface delay value and the modulation delay value are included in the timestamp value.

The transmitting node adds the delayed time value and the timestamp value in a beacon frame, and then transmits the beacon frame in operation S105.

FIG. 11 is a flowchart illustrating a method of synchronizing time in a non-beacon mode, according to an embodiment of the present invention.

In operation S111, a PNC generates and broadcasts a time synchronization frame.

In operation S113, lower nodes that received the time synchronization frame from the PNC synchronizes time with the PNC, based on a timestamp value included in the time synchronization frame.

Then, in operation S115, a node that performed synchronization generates and broadcasts a time synchronization frame by increasing a hop distance value by 1. Operations S111 through S115 are repeated until an end device. Here, a time synchronization frame broadcasted by each node may include broadcast acknowledgement information in order to notify an upper node that the time synchronization frame is received.

Like the upper node, the end device may transmit the time synchronization frame by adding broadcast acknowledgement information to the time synchronization frame. Alternatively, the end device may notify the upper node that the time synchronization frame is received by unicasting a separate acknowledgement response frame.

When at least one time synchronization frame is received from a plurality of upper nodes, a receiving node may perform time synchronization by selecting a time synchronization frame of a node having the lowest hop distance value. However, when some of the time synchronization frames have the same hop distance value, the receiving node may perform time synchronization based on the lowest timestamp value, or compensate a clock based on an average value of the timestamp values.

A node may ignore a time synchronization frame when the time synchronization frame is received from a lower node or a node having the same hop distance value.

Each node periodically receives a time synchronization frame at a predetermined time. If the time synchronization frame is not received at the predetermined time, a node may compensate its clock by compensating a time value based on an average value of error compensated values of consecutive timestamp values received previously.

By using the present invention, an IEEE 802.15.4 MAC-based multihop sensor network can support a mesh topology. Also, an MAC structure having high reliability and low delay time is provided since time in an entire network is synchronized by using a command frame instead of a beacon frame. Also, by adding broadcast acknowledgement information in the command frame, the number of times data is transmitted for time synchronization is reduced, thereby decreasing a load on the entire network. Accordingly, the lifetime of the network increases.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

The terms used herein are for descriptive purposes only and are not intended to limit the meaning or scope of the invention.

While this invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of synchronizing time of a node forming a multihop sensor network, the method comprising:
generating a timestamp after delaying transmitting of a beacon frame; and
adding a delayed time value and a timestamp value to the beacon frame.

2. The method of claim 1, wherein the delayed time value is obtained by performing backoff and clear channel assessment (CCA).

3. The method of claim 1, wherein the timestamp value comprises an interface delay value between a media access control (MAC) layer and a physical (PHY) layer, and a modulation delay value in the PHY layer.

4. A method of synchronizing time of a node in a multihop sensor network, the method comprising:
synchronizing time based on a timestamp value of a first time synchronization frame received from a neighboring node;
generating a second time synchronization frame having an increased hop distance value; and
broadcasting the second time synchronization frame to the multihop sensor network.

5. The method of claim 4, wherein the first time synchronization frame is a time synchronization frame from a node having a lowest hop distance value.

6. The method of claim 4, wherein the first and second time synchronization frames comprise a time value that was delayed before transmission.

7. The method of claim 4, wherein the first and second time synchronization frames comprise broadcast acknowledgement information for notifying time synchronization frame reception.

8. The method of claim 4, further comprising receiving a unicast acknowledgement response frame from a last neighboring node.

9. The method of claim 4, wherein the synchronizing of time comprises, when at least one first time synchronization frame is received, synchronizing time based on a lowest value of timestamp values of the at least one first time synchronization frame.

10. The method of claim 4, wherein the synchronizing of time comprises, when at least one first time synchronization frame is received, synchronizing time based on an average value of timestamp values of the at least one first time synchronization frame.

11. The method of claim 4, further comprising, when a time synchronization frame is not received within a determined time from the neighboring node, compensating a clock based on an average value of error compensated values of consecutive timestamp values that were periodically received previously.
